(19) United States
(12) Patent Application Publication
(10) Pub. No.: US 2010/0159834 A1
(43) Pub. Date: Jun. 24, 2010

(54) SELECTION OF A PAIRED DEVICE FROM A WIRELESS HEADSET

(75) Inventors: Scott Walsh, Foxham (GB); Barry Leigh Margerum, Santa Cruz, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: PLANTRONICS, INC., Santa Cruz, CA (US)

(21) Appl. No.: 12/344,026

(22) Filed: Dec. 24, 2008

(51) Int. Cl. H04B 7/26

(52) U.S. Cl. 455/41.3

(57) ABSTRACT

An apparatus and method are provided for operably coupling a headset to one of a plurality of paired audio gateway devices. In one example, a headset includes a processor, an acoustic transducer, and an audio gateway selector operably coupled to the processor, the selector capable of providing a signal for selecting one of a plurality of paired audio gateway devices.

### TECHNICAL FIELD

The present invention relates generally to headset devices and, more particularly, to a method for connecting to one of a plurality of audio devices from a headset.

### BACKGROUND

Wireless telephone headsets (e.g., Bluetooth, WiFi) are used in various environments, such as call centers and offices, and an individual may use multiple different telephones or headsets over the course of a day in some business circumstances. Wireless headsets may be “paired” with multiple devices, including but not limited to mobile telephones such as cellular telephones, conventional analog or digital telephones, Internet Protocol (IP) telephones, telephone adaptors, and computers running software which act as an IP telephone. To be “paired” means that the devices in question have exchanged security and authentication information to be used at a later date to allow future reconnections. A device that a headset may be paired with will be referred to as an audio gateway (AG) throughout this document.

As people need to initiate and receive calls from multiple audio gateway devices (AG devices), a method and apparatus to simply and efficiently connect to an AG device of choice from a headset is desirable.

### SUMMARY

The present invention provides an advantageous apparatus and method for selecting a paired device from a plurality of devices for connection to a headset.

In one embodiment of the present invention, a headset is provided, the headset comprising a processor, an acoustic transducer, and an audio gateway selector operably coupled to the processor, the selector capable of providing a signal for selecting one of a plurality of paired audio gateway devices.

In accordance with another embodiment of the present invention, another headset is provided, the headset comprising the elements included above and further including an audio gateway access circuit for operably coupling the acoustic transducer to a selected audio gateway device.

In accordance with yet another embodiment of the present invention, a method for connecting a headset to one of a plurality of paired devices is provided, the method comprising providing a headset as noted above. The method further includes pairing a plurality of audio gateway devices, configuring the audio gateway selector with respect to each of the paired audio gateway devices, and selecting one of the audio gateway devices.

Advantageously, the present invention provides a headset and method for connecting to one of a plurality of paired devices from a single headset in a simple manner thereby permitting timely and efficient operation of a headset with paired communication devices.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows a system including a wireless headset and a plurality of audio gateways which the headset may connect to in accordance with an embodiment of the present invention.

FIG. 2 shows a block diagram of a headset of FIG. 1 capable of selecting one from a plurality of audio gateways in accordance with an embodiment of the present invention.

FIG. 3 is a flowchart showing a method of selecting one from a plurality of paired devices in accordance with embodiments of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

The present invention provides an advantageous apparatus and method for connecting to one of a plurality of paired devices from a headset.

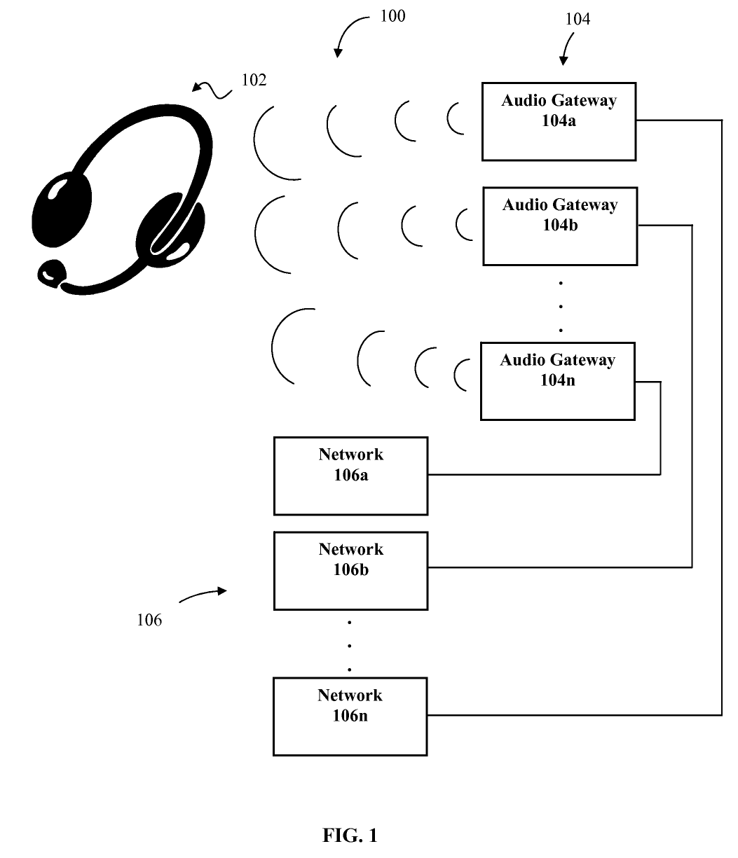

Referring now to FIG. 1, a system 100 is illustrated in accordance with an embodiment of the present invention. System 100 includes a wireless headset 102 and a plurality of audio gateway devices 104 (e.g., devices 104a and 104b to 104n), which are operably coupled or couplable to respective networks 106 (e.g., networks 106a and 106b to 106n). These networks may or may not be the same.

The audio gateway devices 104 may include but are not limited to mobile telephones such as cellular telephones, conventional analog or digital telephones, Internet Protocol (IP) telephones, telephone adaptors (e.g. an access point (AP) which is operably coupled to a network, and an adaptor coupled to a network), and computers running software which act as an IP telephone.

In one example, an AP includes a transceiver and a processor configured to allow a wireless device (e.g., a headset) access to a network connected to the access point (e.g., via a 10/100 Ethernet RJ-45 port). An AP may be any device that allows wireless-equipped computers and other devices to communicate with a wired network. In one example, an AP is able to support WiFi in general, and the 802.11a, 802.11b, and/or 802.11g wireless networking standards in particular. In other examples, the AP may be able to support other wireless networking standards such as Bluetooth.

In a further example, the network may be a communications network which may include a public switched telephone network (PSTN), an integrated services digital network (ISDN), a local area network (LAN), and/or a wireless local area network (WLAN), that support standards such as Ethernet, wireless fidelity (WiFi), and/or voice over internet protocol (VoIP).

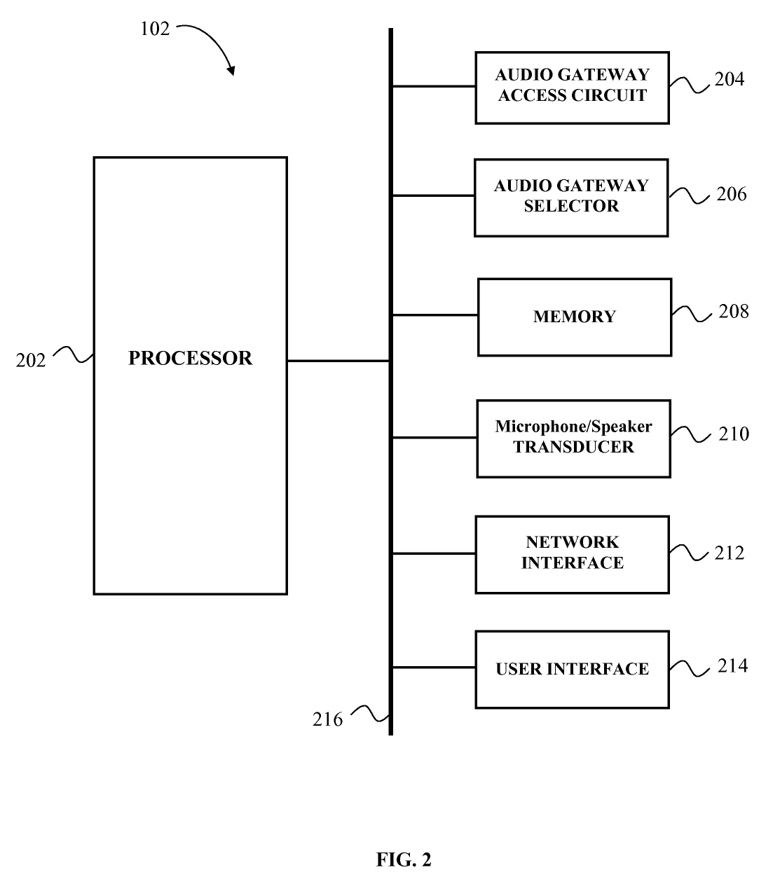

Referring now to FIG. 2 in conjunction with FIG. 1, a block diagram of an example of headset 102 is shown in accordance with an embodiment of the present invention. Headset 102 includes a processor 202 operably coupled via a bus 216 to an audio gateway access circuit 204, an audio gateway selector 206, a memory 208, a transducer 210, an optional network interface 212, and an optional user interface 214.

Processor 202 allows for processing data, in particular managing data between AG access circuit 204, AG selector 206, and memory 208 for selecting and connecting to one of a plurality of AG devices 104. In one embodiment, processor 202 may also process information about access points, service providers, and service accounts for wireless headsets. In one example, processor 202 is a high performance, highly integrated, and highly flexible system-on-chip (SOC), including signal processing functionality such as echo cancellation/reduction and gain control in another example. Processor 202 may include a variety of processors (e.g., digital signal processors), with conventional CPUs being applicable.

AG access circuit 204 allows for pairing of headset 102 to a plurality of audio gateways 104, thus allowing for quick future reconnection with minimal user intervention. Authentication and security data for connection between headset 102 and an AG device 104 may be transmitted and received for pairing between the devices. Data may include but is not limited to a AG identification, an AG device class, a service class UUID value, a password, and an account identification. Data for pairing may be stored in memory 208 or other components, and AG access circuit 204 may utilize the pairing data as needed. In one example, pairing data may be entered via user interface 214 and/or an external computer. Preferably, the pairing data shall be collected by the processor 202 via the audio gateway access circuit 204.

In this example, AG access circuit 204 is an individual component operably coupled to other components of headset 102 via bus 216, but AG access circuit 204 may be placed in various locations, for example being integrated with processor 202, stored in memory 208, or being provided from outside of headset 102, for example at an external server.

In one embodiment, audio gateway selector 206 is a simple user interface for selection of a paired AG device from a plurality of paired AG devices. In one example, AG selector 206 includes a single button and/or switch for toggling between and initiating connection to paired AG devices. In another example, a plurality of dedicated buttons may be used for initiating connection to each paired AG device or groups of paired AG devices. In yet other examples, AG selector 206 may include voice recognition software and/or hardware or, a touch sensitive icon driven LCD for selection of a paired AG device. AG selector 206 may be configured by various means, including but not limited to user interface 214 and/or an external computer.

Memory 208 may include a variety of memories, and in one example includes SDRM, ROM, flash memory, or a combination thereof. Memory 208 may further include separate memory structures or a single integrated memory structure. In one example, memory 208 may be used to store passwords, network and telecommunications programs, and/or an operating system (OS), and is non-volatile, thus allowing for persistent data storage between power cycles of the headset. In one embodiment, memory 208 may store AG pairing data from AG access circuit 204.

Transducer 210 may include an acoustic transducer, such as a microphone, a speaker, or a combination thereof, for transmission of sound (such as from the user's mouth or to the user's ear based upon signals from an audio source). Transducer 210 may also include a plurality of separate transducers for performing different functions. The transducer can be any type of electromagnetic, piezoelectric, or electrostatic type of driving element, or a combination thereof, or another form of driving element, for generating sound waves from the output face of the transducer. In one embodiment, the transducer may receive signals through wireless communication channels, such as by Bluetooth® protocols and hardware, in one example.

Network interface 212 allows for communication with APs, and in one example includes a transceiver for communicating with a wireless local area network (LAN) radio transceiver (e.g. wireless fidelity (WiFi), Bluetooth, ultra wideband (UWB) radio, etc.) for access to a network (e.g., a wireless LAN or the Internet), or an adaptor for providing wired communications to a network. In one example, network interface 212 is adapted to derive a network address for the headset using the headset's electronic serial number, which is used to identify the headset on the network. In one embodiment, the electronic serial number may be the headset's Media Access Control (MAC) address; however, the electronic serial number may be any number that is mappable to a network address. Network interface 212 is adapted to communicate over the network using the network address that it derives for the headset. In one embodiment, network interface 212 is able to transmit and receive digital and/or analog signals, and in one example communicates over the network using IP, wherein the network interface uses the headset's MAC address or another globally unique address as its IP address. In particular, network interface 212 may be operably coupled to a network via the IEEE 802.11 protocol. However, the network interface 212 may communicate using any of various protocols known in the art for wireless or wired connectivity. In one embodiment, the functionality of network interface 212 and audio gateway access circuit 204 may be provided on a single chip, such as a single Bluetooth chip.

An example of an applicable network interface and the Internet protocol layers (and other protocols) of interest for the present invention are described in pending U.S. patent application Ser. No. 10/091,905 filed Mar. 4, 2002, the full disclosure of which is hereby incorporated by reference for all purposes.

User interface 214 allows for manual communication between the headset user and the headset, and in one example includes an audio and/or visual interface such that a prompt may be provided to the user's ear and/or an LED may be lit. In one embodiment, user interface 214 may be used to configure AG selector 206 to be assigned to a particular AG(s) and/or may be used to enter pairing data, such as identification data, account data, and passwords. In another embodiment, an external device, such as a mobile telephone or computer, may be used to configure AG selector 206 via any means available by the network interface 212.

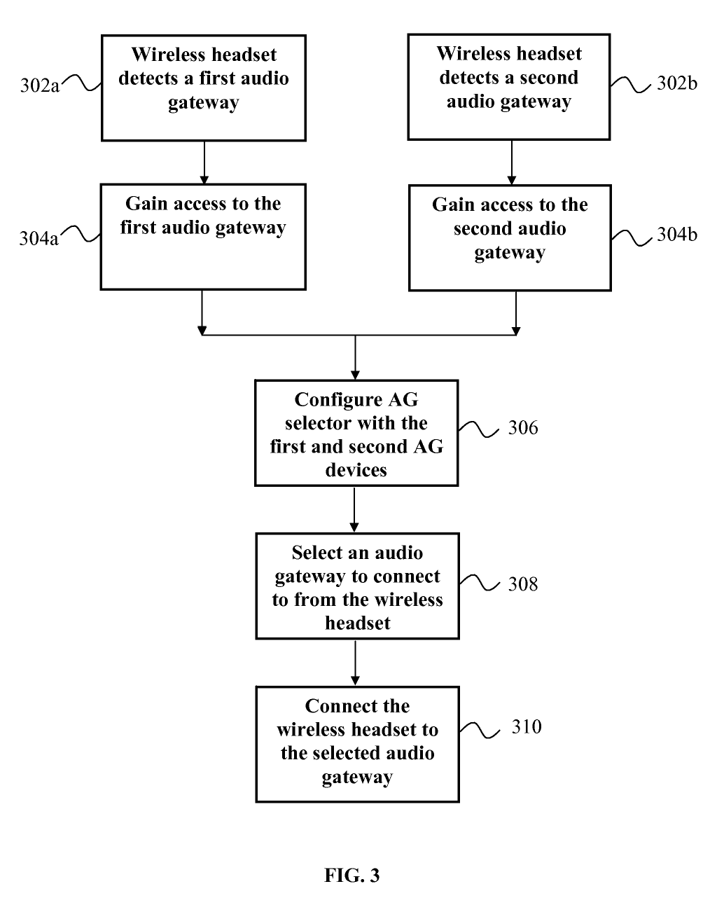

Referring now to FIG. 3 in conjunction with FIGS. 1 and 2, a flowchart of a method for selecting and connecting to a paired AG device from a headset is illustrated in accordance with an embodiment of the present invention. At step 302a, wireless headset 102 detects a first AG, and at step 304a, wireless headset 102 exchanges access data with and gains access to the first AG, thereby being paired with the first AG. At step 302b, wireless headset 102 detects a second AG, and at step 304b, wireless headset 102 exchanges access data with gains access to the second AG, thereby being paired with the second AG. Headset 102 may be paired with the first and second AGs substantially at the same time or at different times. Wireless headset 102 may gain access to the AG devices by transmitting and/or exchanging data such as identification data, account data, and/or passwords. At step 306, AG selector 206 is configured with respect to the first and second AG devices, for example via a user interface or the AG selector itself. At step 308, an AG is selected by the user via AG selector 206, and at step 310, headset 102 connects to the selected AG via AG access circuit 204.

Advantageously, the present invention provides a headset and method for connecting to one of a plurality of paired devices from a single headset in a simple manner thereby permitting timely and efficient operation of a headset with paired communication devices.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A headset, comprising:
a processor;
an acoustic transducer; and
an audio gateway selector operably coupled to the processor, the selector capable of providing a signal for selecting one of a plurality of paired audio gateway devices.

2. The headset of claim 1, wherein the audio gateway selector includes one of a switch, a button, voice recognition software/hardware, and a touch sensitive LCD.

3. The headset of claim 1, wherein the audio gateway selector is configured to at least one of the plurality of paired audio gateway devices.

4. The headset of claim 1, wherein the audio gateway selector includes a plurality of switches, each switch correlated to a different audio gateway device.

5. The headset of claim 1, further comprising a user interface for configuring the audio gateway selector.

6. The headset of claim 1, further comprising a user interface for entering pairing data between the headset and an audio gateway device.

7. The headset of claim 1, further comprising an audio gateway access circuit for pairing or connecting the headset to an audio gateway device.

8. The headset of claim 1, further comprising a memory for storing pairing data between the headset and an audio gateway device.

9. A headset, comprising:
a processor;
an acoustic transducer;
an audio gateway selector operably coupled to the processor, the selector capable of providing a signal for selecting one of a plurality of paired audio gateway devices; and
an audio gateway access circuit for operably coupling the acoustic transducer to a selected audio gateway device.

10. The headset of claim 9, wherein the audio gateway selector includes a switch configured to at least one of the plurality of paired audio gateway devices.

11. The headset of claim 9, wherein the audio gateway selector includes a plurality of switches, each switch correlated to a different audio gateway device.

12. The headset of claim 9, further comprising a user interface for configuring the audio gateway selector.

13. The headset of claim 9, further comprising a user interface for entering pairing data between the headset and an audio gateway device.

14. The headset of claim 9, further comprising a memory for storing pairing data between the headset and an audio gateway device.

15. A method of operably coupling a headset to one of a plurality of paired audio gateway devices, the method comprising:
providing a headset including a processor, an acoustic transducer, and an audio gateway selector operably coupled to the processor, the selector capable of providing a signal for selecting one of a plurality of paired audio gateway devices;
pairing a plurality of audio gateway devices;
configuring the audio gateway selector with respect to each of the paired audio gateway devices; and
selecting one of the audio gateway devices.

16. The method of claim 15, wherein one of the audio gateway devices is selected by a single switch.

17. The method of claim 15, wherein one of the audio gateway devices is selected by one of a plurality of switches.

18. The method of claim 15, further comprising providing pairing data between the headset and each of the plurality of audio gateway devices via a user interface.

19. The method of claim 15, further comprising storing pairing data between the headset and an audio gateway device.

20. The method of claim 15, further comprising operably coupling the acoustic transducer to a selected audio gateway device.
